(19) United States
(12) Patent Application Publication
(10) Pub. No.: US 2018/0201481 A1
(43) Pub. Date: Jul. 19, 2018

(54) ELEVATOR CARRIAGE SUPPORT STRUCTURE

(71) Applicant: ARTICULATED FUNICULATOR AB, Stockholm (SE)

(72) Inventor: Fritz KING, Stockholm (SE)

(21) Appl. No.: 15/743,055

(22) PCT Filed: Jun. 28, 2016
(86) PCT No.: PCT/SE2016/050638

§ 371 Date: Jan. 9, 2018

(30) Foreign Application Priority Data
Jul. 10, 2015 (SE) 1551010-0

(51) Int. Cl. B66B 11/02; B66B 7/04

(52) U.S. Cl. CPC B66B 11/0206; B66B 2009/006; B66B 7/04

(57) ABSTRACT

Support structure (10) for supporting a carriage (14) on a track (12) of an elevator system, where the support structure (10) comprises a track coupling arrangement (16) for movement along the track (12), a carriage support member (30) configured to rotatably support the carriage (14) for rotation about a pitch axis (32), and a linkage mechanism (24) connected between the carriage support member (30) and the track coupling arrangement (16), wherein the linkage mechanism (24) is configured such that the support structure (10) can be moved between an expanded state and a collapsed state, where the pitch axis (32) is closer to the track (12) in the collapsed state than in the expanded state.

### TECHNICAL FIELD

The present disclosure generally relates to a support structure for supporting elevator carriages. In particular, a support structure for supporting a carriage on a track of an elevator system and an elevator system comprising the support structure are provided.

### BACKGROUND

Various types of elevator systems for vertically transporting people and/or goods are known. Some elevator systems include a rotatably supported cabin such that the cabin can be maintained in a horizontal orientation as the cabin transitions between horizontal and vertical track portions.

The Articulated Funiculator (R) is a new concept of vertical transportation which is described in WO 2013159800 A1. With this concept, two stations in a vertical building or in an underground shaft may be separated by a large distance of, for example, 100 meters. The Articulated Funiculator may be used in tall buildings, deep underground subway stations and deep mines.

US 2001020429 A1 discloses an autonomous transport system where a cabin is connected to a rolling traction wheel assembly with a cantilever. The cantilever holds the cabin with a swivel joint at a fixed distance from the wheel guides.

The transport system in US 2001020429 A1 requires rather large elevator shafts which consume large volumes of the building and thereby reduce the percentage of usable floor space in the building. Since only a relatively low percentage of the floor space is available to lease, the economic potential of the building is reduced.

### SUMMARY

Accordingly, one object of the present disclosure is to provide a simple support structure for supporting a carriage on a track of an elevator system that requires less space within an elevator shaft and is well adapted to move along curved tracks.

According to one aspect, a support structure for supporting a carriage on a track of an elevator system is provided, where the support structure comprises a track coupling arrangement for movement along the track, a carriage support member configured to rotatably support the carriage for rotation about a pitch axis, and a linkage mechanism connected between the carriage support member and the track coupling arrangement, wherein the linkage mechanism is configured such that the support structure can be moved between an expanded state and a collapsed state, where the pitch axis is closer to the track in the collapsed state than in the expanded state.

The carriage may be a passenger carriage and/or a load carriage. The carriage may alternatively be referred to as a pod, cabin or car. Several carriages may be used in the elevator system. The carriages may be individually routed on the track or collectively as trains with two or more carriages. In case the carriages are driven collectively as trains, the carriages may be driven individually or interconnected, for example with cables.

The track may include a single rail or several rails. One suitable track is constituted by a pair of rails. The track may contain helical sections such that the carriage can roll in space as the support structure with the carriage is moved along the track.

The pitch axis of the track is substantially perpendicular to the roll and yaw axes of the track. The pitch axis thus constitutes an axis substantially perpendicular to a local extension direction (e.g. travel direction) of the track. The pitch axis may be substantially parallel with a lateral axis of the track. In case a track with a pair of rails is used as track, the support structure may be configured such that the pitch axis is substantially parallel to a separating direction (i.e. in the lateral direction) between the two rails.

The carriage support member may adopt various different configurations for rotatably supporting the carriage. According to one variant, the carriage support member comprises a swivel mount. One type of swivel mount is a bearing mount that attaches the linkage mechanism to the carriage. The swivel mount allows rotation of the carriage about a pivot point collocated with the pitch axis.

In a more simple form, the carriage support member comprises an articulated joint with a bearing such as a shaft rotationally coupled to the carriage. The linkage mechanism may then be connected to the shaft.

The elevator system may for example be used in a tall building or underground to access a deep underground substation or a deep mine.

The track coupling arrangement may comprise a first and second track coupling member and the linkage mechanism may comprise a first and second linkage connected between the carriage support member and the first and second track coupling member, respectively, where each of the first and second linkage comprises a pivot axis substantially parallel with the pitch axis for pivotal movement between the first and second linkage and the first and second track coupling member, respectively. Thereby, the first track coupling member can be attached to a first portion of the track and the second track coupling member can be attached to a second portion of the track, inclined with respect to the first portion. One or both of the linkages may be constituted by a telescoping arm that can be made longer and shorter.

At least one of the first and second track coupling member may also comprise a further pivot connection with a pivot axis parallel with a roll axis of the track. Thereby, one linkage may pivot with respect to the track coupling member, to which it is attached, about the roll axis. Since the first and second track coupling members are thereby allowed to rotate relative to each other about the roll axis, the support structure can follow helical track portions.

At least one of the first and second track coupling member may also comprise a further pivot connection with a pivot axis parallel with a yaw axis of the track. Thereby, one track coupling member may yaw relative to the respective linkage, to which it is attached. The support structure can in this manner be made to follow tracks curved in the plane of the rails.

The linkages may comprise any type of link members suitable for carrying the weight of the carriage, such as struts or link arms. In one variant, the first linkage is constituted by a first rigid arm and the second linkage is constituted by a second rigid arm.

The first and second linkage may each comprise two link members and two further pivot axes may be formed between the respective two link members. One link member of each linkage may be pivotally connected to the respective track coupling member. With this variant, the movement between the expanded state and the collapsed state may be accomplished also in case the first and second track coupling members are fixed relative to each other along a local extension direction of the track.

As a further alternative linkage mechanism, a telescoping arm may be used. The telescoping arm may alone carry the weight of the carriage. Thus, according to one variant, the support structure comprises a track coupling arrangement with one track coupling member and a telescoping arm connected between the track coupling member and the carriage support member. The telescoping arm may extend substantially perpendicular to the local travel direction of the track and substantially perpendicular to the pitch axis. In other words, in case a track with two rails is used, the telescoping arm may extend substantially normal to a plane formed between the rails. Thus, by telescoping the arm in and out, the support structure can be moved between the collapsed state and the expanded state.

The support structure may be movable between the collapsed state and the expanded state such that the pitch axis and the pivot axes are substantially aligned in the collapsed state. The pivot axes here may be the pivot axes between the first and second linkage and the first and second track coupling member, respectively. The pitch axis and the pivot axes may be aligned along a line substantially parallel with the local extension direction of the track when the support structure adopts the collapsed state.

The first and second track coupling members may be configured to move relative to each other along the track. The first and second track coupling members may thereby be moved between a separated state and a compacted state, where the first and second track coupling members are closer to each other in a direction along the track in the compacted state. The support structure may thus be configured such that the carriage is at least partly between the track coupling members (along the local extension direction of the track) when the support structure adopts the compacted state.

The support structure may additionally be configured such that the carriage can rotate about a yaw axis, perpendicular to the pitch axis. The yaw movement may for example be realized by the carriage support member.

Thus, the carriage support member may be configured to rotatably support the carriage for rotation about the yaw axis. This may for example be accomplished by means of a carriage support member comprising two perpendicular swivel mounts, e.g. one swivel mount for a rotatable connection between the carriage support member and the linkage mechanism about the pitch axis and one swivel mount for a rotatable connection between the carriage support member and the carriage about the yaw axis. Such carriage support member may have an L-shaped or U-shaped appearance.

The track coupling arrangement may comprise one or more track coupling members to enable the movement along the track. Each track coupling member may in turn comprise one or more wheel assemblies for engaging a rail portion of the track to establish the movement along the track. The wheel assembly may engage a portion of the track rail on two or more sides of the rail. For this purpose, each wheel assembly may comprise at least two wheels for engaging opposite sides of a track rail.

For example, each track coupling member may comprise two wheel assemblies for engaging a respective rail portion of two separate rails. Each wheel assembly may comprise two wheels for engaging one side of a track rail and two wheels for engaging an opposite side of the track rail. A corresponding amount (in this case two) of lateral wheels may also be provided in each wheel assembly for engaging an outer or lateral part of the track rail.

The carriage support member may be configured to support the carriage for a rotation of 360° about the pitch axis when the support structure adopts the expanded state. When the support structure adopts the collapsed state, the carriage may be positioned such that one of its longitudinal sides is close to the track. For example, when the support structure adopts the collapsed state, the closest side of the carriage may be positioned within 500 mm from the track, such as within 200 mm.

According to a further aspect, there is provided an assembly comprising a support structure according to the present disclosure and a carriage.

According to a further aspect, there is provided an elevator system comprising a track, a support structure according to the present disclosure and a carriage. The support structure may support the carriage such that the pitch axis passes through the centre of mass of the carriage.

The carriage may have a vertically elongated appearance. This means that the largest dimension of the carriage is in a direction normal to the standing or seating plane for passengers (or any load).

The support structure according to the present disclosure is not limited to any particular type of propulsion system. For example, all carriages in the elevator system may be driven with a cable or set of cables or each carriage may have an individual propulsion system. Two or more different types of propulsion systems may also be combined within the elevator system.

The support structure may be moved between the expanded state and the collapsed state by means of one or more motors. For example, in case two track coupling members pivotally coupled to two linkages are used, a motor may be provided at each pivot axis.

A motor may also be provided to control the rotation of the carriage about the pitch axis. Alternatively, the carriage may be rotated about the pitch axis by means of gravity.

As an alternative to motors for moving the support structure between the expanded state and the collapsed state, the carriage may be moved towards and away from the track by a pure mechanical action. Such mechanical action may be realized with a guiding rail or similar engaging the carriage support member to move the carriage towards and away from the track as the support structure moves along the track.

Some exemplary variants are here presented as items:
1. Support structure for supporting a carriage on a track of an elevator system, the support structure comprising:
   a track coupling arrangement for movement along the track,
   a carriage support member configured to rotatably support the carriage for rotation about a pitch axis, and
   a linkage mechanism connected between the carriage support member and the track coupling arrangement, wherein the linkage mechanism is configured such that the support structure can be moved between an expanded state and a collapsed state, where the pitch axis is closer to the track in the collapsed state than in the expanded state.
2. The support structure according to item 1, wherein the track coupling arrangement comprises a first and second track coupling member and wherein the linkage mechanism comprises a first and second linkage connected between the carriage support member and the first and second track coupling member, respectively, each comprising a pivot axis substantially parallel with the pitch axis for pivotal movement between the first and second linkage and the first and second track coupling member, respectively.
3. The support structure according to item 2, wherein the pitch axis and the pivot axes are substantially aligned in the collapsed state.
4. The support structure according to item 2 or 3, wherein the first and second track coupling members are configured to move relative to each other along the track.
5. The support structure according to any of the preceding items, wherein the support structure is configured such that the carriage can rotate about a yaw axis, perpendicular to the pitch axis.
6. The support structure according to item 5, wherein the carriage support member is configured to rotatably support the carriage for rotation about the yaw axis.
7. The support structure according to any of the preceding items, wherein the track coupling arrangement comprises at least one wheel assembly for engaging a rail portion of the track to establish the movement along the track.
8. The support structure according to any of the preceding items, wherein the carriage support member is configured to support the carriage for a rotation of 360° about the pitch axis when the support structure adopts the expanded state.
9. Elevator system comprising a track, a support structure according to any of the preceding items and a carriage.
10. The elevator system according to item 9, wherein the support structure supports the passenger carriage such that the pitch axis passes through the centre of mass of the carriage.

### BRIEF DESCRIPTION OF THE DRAWINGS

Further details, advantages and aspects of the present disclosure will become apparent from the following embodiments taken in conjunction with the drawings, wherein:

FIG. 1a: shows a schematic representation of a support structure in an expanded state; and

FIG. 1b: shows a schematic representation of the support structure in FIG. 1a in a collapsed state.

### DETAILED DESCRIPTION

In the following, a support structure for supporting a carriage on a track of an elevator system and an elevator system comprising the support structure will be described. The same reference numerals will be used to denote the same or similar structural features.

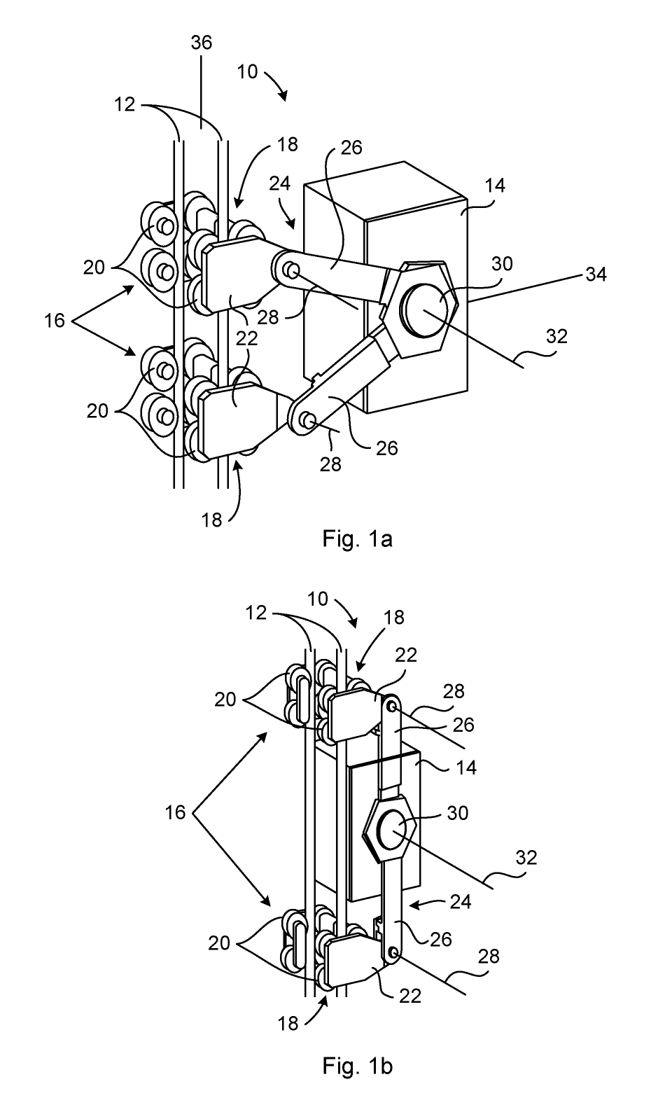

With reference to FIGS. 1a and 1b, FIG. 1a shows a schematic representation of a support structure 10 in an expanded state and FIG. 1b shows a schematic representation of a support structure 10 in a collapsed state.

FIGS. 1a and 1b show a portion of a track 12 of an elevator system, a support structure 10 and a carriage 14. The track 12 comprises two parallel rails. The track 12 may contain a variety of straight, inclined, curved and helical portions. In FIGS. 1a and 1b, a straight portion of the track 12 is illustrated.

The support structure 10 comprises a track coupling arrangement 16. The track coupling arrangement 16 comprises a first track coupling member 18 and a second track coupling member 18. With the orientation of the support structure 10 in FIG. 1, the first track coupling member 18 is above the second track coupling member 18.

The first and second track coupling member 18 each comprises two wheel assemblies 20. Each wheel assembly 20 in turn comprises four wheels, two wheels engaging one side of the rail and two wheels engaging the opposite side of the rail. The wheel assemblies 20 of each track coupling member 18 are substantially aligned along the travel direction of the track 12. The track coupling arrangement 16 is thereby configured to move along the track 12.

Optionally, each wheel assembly 20 may further comprise two lateral wheels such that for each track coupling member 18, two lateral wheels engage a lateral side of a first rail and two lateral wheels engage a lateral side of a second rail such that the lateral wheels engage opposite sides of the track 12.

The wheel assemblies 20 of the respective track coupling member 18 are connected to each other with a base structure such that they are maintained aligned along the travel direction of the track 12. The base structure of each track coupling member 18 also comprises a plate member 22.

The support structure 10 further comprises a linkage mechanism 24. In FIGS. 1a and 1b, the linkage mechanism 24 is implemented as a first and second linkage 26. The first and second linkage 26 are pivotally connected to the first and second track coupling member 18, respectively. More specifically, the first and second linkage 26 are connected with their ends to a distal end portion (opposite to the track 12) of the plate member 22 of each track coupling member 18.

Each of the first and second linkage 26 is constituted by a rigid link arm. However, one or both of the first and second linkage 26 may alternatively be constituted by telescoping arms. The first and second linkage 26 are allowed to rotate about a pivot axis 28. Thus, the first and second linkage 26 are rotatably attached to the first and second track coupling member 18, respectively, about the pivot axes 28. The particular configuration of each track coupling member 18 may be varied in many ways to rotationally couple the linkages 26 to the track coupling members 18.

The pivot axes 28 are parallel. The pivot axes 28 are also substantially parallel with a separating direction between the two rails of the track 12. With a separating direction is meant a lateral direction of the track 12, i.e. a direction between the rails that is perpendicular to the travel direction of the track 12.

At the ends of the first and second linkage 26, opposite to the pivot axes 28, the linkages 26 are rotatably connected to a carriage support member 30 for rotation about a common axis, namely a pitch axis 32. The pitch axis 32 is substantially parallel with the pivot axes 28. Thus, the pitch axis 32 is substantially parallel with the separating direction between the two rails of the track 12.

The carriage support member 30 is implemented as a swivel mount with a pivot point collocated with the pitch axis 32. Thus, the carriage support member 30 is configured to rotatably support the carriage 14 about the pitch axis 32.

Due to the pivotal connections between the track coupling members 18, the linkages 26 and the carriage support member 30, the first and second track coupling member 18 are configured to move relative to each other along the track 12. At least one of the first and second track coupling member 18 may also comprise a further pivot connection (not shown) with a pivot axis parallel with a yaw axis 34 of the track 12. Thereby, one track coupling member 18 may yaw relative to the respective linkage 26, to which it is attached. The support structure 10 can in this manner be made to follow tracks 12 curved in the plane of the rails.

In a corresponding manner, at least one of the first and second track coupling member 18 may also comprise a further pivot connection (not shown) with a pivot axis parallel with a roll axis 36 of the track 12. Thereby, one linkage 26 may pivot with respect to the track coupling member 18, to which it is attached, about the roll axis 36. Since the first and second track coupling member 18 are thereby allowed to rotate relative to each other about the roll axis 36, the support structure 10 can follow helical track portions.

The carriage 14 in FIGS. 1a and 1b has an external appearance of an elongated box. The carriage 14 is vertically oriented such that passengers can be maintained in their upright seating or standing position.

The representations of the carriage support member 30 and the carriage 14 are merely schematic. The carriage support member 30 may for example additionally be configured such that the carriage 14 can rotate about the yaw axis 34. For this purpose, the carriage support member 30 may comprise a further swivel mount.

In the expanded state of the support structure 10 in FIG. 1a, the carriage support member 30 is distanced from the track 12. The first and second track coupling members 18 adopt a compact state where they are closer to each other along the extension direction of the track 12 in comparison with a separated state.

In the expanded state of the support structure 10, the carriage 14 is allowed to rotate 360° about the pitch axis 32. The expanded state may for example be adopted as the support structure 10 travels on a curved track 12 (curved in a plane perpendicular to the pitch axis 32) in order to avoid interference between the track 12 and the carriage 14 while still maintaining the carriage 14 in the vertical orientation.

The expanded state of the support structure 10 may also be adopted at a horizontal portion of the track 12, e.g. when passengers enter and leave the carriage 14.

In the collapsed state of the support structure 10 in FIG. 1b, the pitch axis 32 is closer to the track 12 than in the expanded state in FIG. 1a. The collapsed state enables the support structure 10 and the carriage 14 to travel through narrow elevator shafts.

As can be seen in FIG. 1b, the pitch axis 32 and the pivot axes 28 are substantially aligned. More specifically, the pitch axis 32 and the pivot axes 28 are aligned along a line substantially parallel with the local extension direction of the track 12.

Furthermore, the track coupling members 18 adopt a separated state when the support structure 10 adopts the collapsed state. As can be seen in FIG. 1b, the separated state of the track coupling members 18 allows the carriage 14 to fit partly between the track coupling members 18 along the extension direction of the track 12. This enables an even more compact configuration of the support structure 10.

Since the first and second track coupling members 18 are rotatable about the pivot axes 28, the track coupling members 18 can rotate with respect to each other and follow curved portions of the track 12 (portions curved about an axis parallel with the pitch axis 32). If the first and second track coupling members 18 are rotatable with respect to each other also about an axis parallel with the roll axis 36 and/or the yaw axis 34, the support structure 10 can also follow helical portions of the track 12 and/or portions of the track 12 curved in the plane of the rails.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. Support structure for supporting a carriage on a track of an elevator system, the support structure comprising:
a track coupling arrangement for movement along the track,
a carriage support member configured to rotatably support the carriage for rotation about a pitch axis, and
a linkage mechanism connected between the carriage support member and the track coupling arrangement, wherein the linkage mechanism is configured such that the support structure can be moved between an expanded state and a collapsed state, where the pitch axis is closer to the track in the collapsed state than in the expanded state,
wherein the track coupling arrangement comprises a first and second track coupling member and wherein the linkage mechanism comprises a first and second linkage connected between the carriage support member and the first and second track coupling member, respectively, each comprising a pivot axis substantially parallel with the pitch axis for pivotal movement between the first and second linkage and the first and second track coupling member, respectively.

2. (canceled)

3. The support structure according to claim 1, wherein the pitch axis and the pivot axes are substantially aligned in the collapsed state.

4. The support structure according to claim 1, wherein the first and second track coupling members are configured to move relative to each other along the track.

5. The support structure according to claim 1, wherein the support structure is configured such that the carriage can rotate about a yaw axis, perpendicular to the pitch axis, and wherein the carriage support member is configured to rotatably support the carriage for rotation about the yaw axis.

6. The support structure according to claim 1, wherein the track coupling arrangement comprises at least one wheel assembly for engaging a rail portion of the track to establish the movement along the track.

7. The support structure according to claim 1, wherein the carriage support member is configured to support the carriage for a rotation of 360° about the pitch axis when the support structure adopts the expanded state.

8. Elevator system comprising a track, a support structure according to claim 1 and a carriage.

9. The elevator system according to claim 8, wherein the support structure supports the passenger carriage such that the pitch axis passes through the centre of mass of the carriage.

10. The support structure according to claim 3, wherein the first and second track coupling members are configured to move relative to each other along the track.

11. The support structure according to claim 3, wherein the support structure is configured such that the carriage can rotate about a yaw axis, perpendicular to the pitch axis, and wherein the carriage support member is configured to rotatably support the carriage for rotation about the yaw axis.

12. The support structure according to claim 3, wherein the track coupling arrangement comprises at least one wheel assembly for engaging a rail portion of the track to establish the movement along the track.

13. The support structure according to claim 3, wherein the carriage support member is configured to support the carriage for a rotation of 360° about the pitch axis when the support structure adopts the expanded state.

14. The support structure according to claim 4, wherein the support structure is configured such that the carriage can rotate about a yaw axis, perpendicular to the pitch axis, and wherein the carriage support member is configured to rotatably support the carriage for rotation about the yaw axis.

15. The support structure according to claim 4, wherein the track coupling arrangement comprises at least one wheel assembly for engaging a rail portion of the track to establish the movement along the track.

16. The support structure according to claim 4, wherein the carriage support member is configured to support the carriage for a rotation of 360° about the pitch axis when the support structure adopts the expanded state.

17. The support structure according to claim 5, wherein the track coupling arrangement comprises at least one wheel assembly for engaging a rail portion of the track to establish the movement along the track.

18. The support structure according to claim 5, wherein the carriage support member is configured to support the carriage for a rotation of 360° about the pitch axis when the support structure adopts the expanded state.

19. The support structure according to claim 6, wherein the carriage support member is configured to support the carriage for a rotation of 360° about the pitch axis when the support structure adopts the expanded state.
